(19) United States
(12) Patent Application Publication
(10) Pub. No.: US 2009/0248534 A1
(43) Pub. Date: Oct. 1, 2009

(54) SYSTEM AND METHOD FOR OFFERING AN AUCTION BUNDLE IN AN ONLINE ADVERTISING AUCTION

(75) Inventors: Ali Dasdan, San Jose, CA (US); Rica Gonen, Sunnyvale, CA (US)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/060,153

(22) Filed: Mar. 31, 2008

(51) Int. Cl. G06Q 30/00

(52) U.S. Cl. 705/26

(57) ABSTRACT

An improved system and method for offering an auction bundle in an online advertising auction is provided. A pricing engine may determine a price of an auction bundle that may include a bid for an input of a search engine such as a keyword, an output of search engine such as a URL appearing in search results, or a combination of an input and an output of a search engine. In an implementation, bids may be received from bidders for auction bundles, click-through rates for web page placements may be obtained for auction bundles, and the bidders with the highest gain for the auction bundles may be determined for a search query. The advertisements of the bidders with the highest gain may be allocated to web page placements for display with query results.

### FIELD OF THE INVENTION

The invention relates generally to computer systems, and more particularly to an improved system and method for offering an auction bundle in an online advertising auction.

### BACKGROUND OF THE INVENTION

An online auction is a widely used mechanism for selling advertisements using Internet search engines. Each time a user enters a search term into a search engine, the online auction allocates the advertising space within that user's search results. There are hundreds of millions of separate online auctions conducted every day. Search engines' revenues from online auctions are on the order of ten billion dollars per year. As a result, these advertising auctions are receiving considerable attention from practitioners and academics. For example, Abrams, Z., Revenue Maximization When Bidders Have Budgets, In Proceedings the ACM-SIAM Symposium on Discrete Algorithms, 2006, considers the role of bid increment; Feng, J., Bhargava, H., and Pennock, D., Implementing Sponsored Search in Web Search Engines: Computational Evaluation of Alternative Mechanisms, INFORMS Journal on Computing, 2005, consider the implications of ranking rules; and Borgs, C., et al., Multi-Unit Auctions with Budget-Constrained Bidders, In Proceedings the Sixth ACM Conference on Electronic Commerce, Vancouver, BC, 2005 consider the effect of budgets; and Szymanski, B. and Lee, J., Impact of ROI on Bidding and Revenue in Sponsored Search Advertisement Auctions, Second Workshop on Sponsored Search Auctions, 2006, use simulations to study sponsored search auctions.

In addition to focusing on maximizing revenue for selling advertisements using Internet search engines in online keyword auctions, there needs to be new methods introduced to grow revenue selling advertisements using Internet search engines for online advertising auction. Deployment of any new methods should be integrated transparently with legacy online advertising systems for selling advertisements using Internet search engines. Moreover, any integration of new methods should symbiotically increase revenue of existing online advertising systems for selling advertisements using Internet search engines.

What is needed is a system and method that may allow additional effective options for online advertising auctions using Internet search engines. Such a system and method should support maximizing revenue for the auctioneer.

### SUMMARY OF THE INVENTION

The present invention provides a system and method for offering an auction bundle in an online advertising auction. A pricing engine for an auction bundle may be provided for determining a price of an auction bundle that may include a bid for an input of a search engine such as a search query, consisting one or more keywords, an output of search engine results such as a URL appearing in search results, or a combination of an input and an output of a search engine. In an embodiment for conducting an online auction for offering an auction bundle, bids may be received from bidders for auction bundles, click-through rates (CTR) for web page placements may be obtained for auction bundles, and advertisements of the bidders with the highest gain may be allocated to web page placements for display with query results. Advertisements for winning bids of keyword auctions may be allocated web page placements in the sponsored search area of the web page displaying query results, and advertisements for winning bids of URLs may be allocated a web page placement in a modified listing of the query results. The advertisements of the bidders with the highest gain allocated to web page placements may be served for display with query results.

To allocate advertisements of the bidders with the highest gain to web page placements, the auction bundles may be partitioned into unbundled bids and may be ranked in decreasing order of their gain. Advertisements of the bidders with the highest gain may be allocated to web page placements, and prices may be determined for auction bundles allocated web page placements. If the auction bundle includes a bid for an input of a search engine, such as a keyword, and a bid for an output of search engine, such as a URL appearing in search results, then the price of the auction bundle may be computed in an embodiment as the sum of a payment calculated for a second price keyword auction and a payment calculated for a second price auction for placement of an advertisement for a URL in the output of the search results.

The present invention may support many applications for offering an auction bundle in an online advertising auction. For example, online advertising applications may use the present invention for pricing auction bundles that may flexibly include auctioning advertisement placement for keywords of search engines. Or online advertising applications may use the present invention for pricing auction bundles that may flexibly include auctioning advertisement placement for URLs output in the search results of search engines. For any of these applications, online advertisement auctions may flexibly offer auction bundles and price the auction bundles to maximize the revenue of the auctioneer.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for offering an auction bundle in an online advertising auction, in accordance with an aspect of the present invention;

FIG. 3 is a flowchart generally representing the steps undertaken in one embodiment for offering an auction bundle in an online advertising auction, in accordance with an aspect of the present invention; and

FIG. 4 is a flowchart generally representing the steps undertaken in one embodiment for allocating the advertisements of bidders to web page placements for display with query results for a search query in an online advertising auction, in accordance with an aspect of the present invention.

### DETAILED DESCRIPTION

### Exemplary Operating Environment

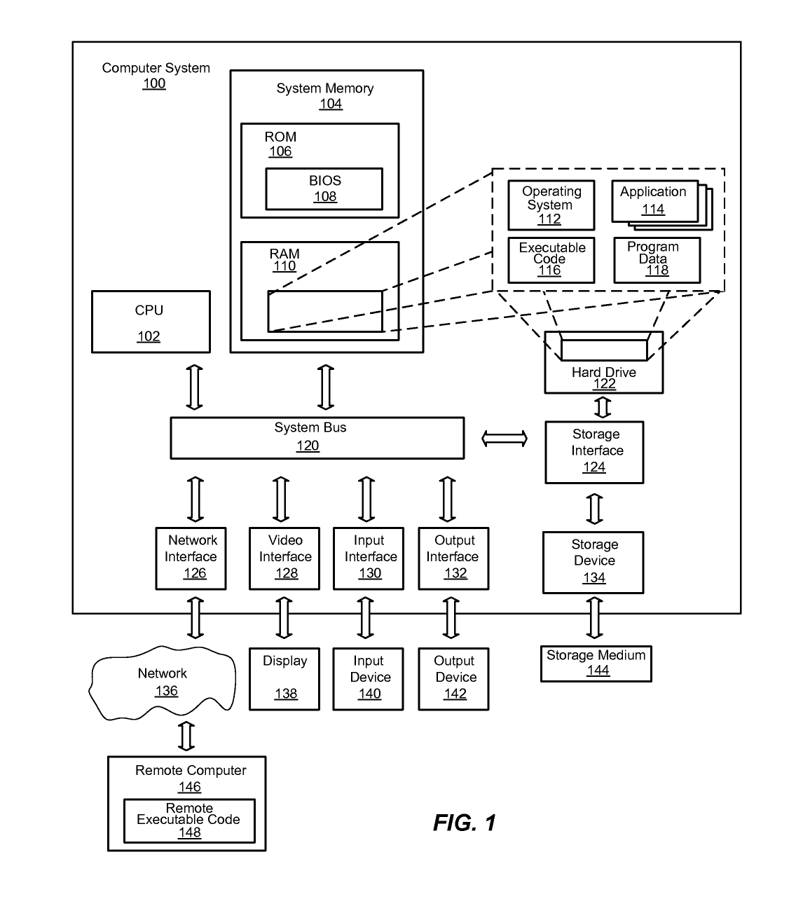

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Auction Bundle in an Online Advertising Auction

The present invention is generally directed towards a system and method for offering an auction bundle in an online advertising auction. An auctioned bundle as used herein may mean a bid for one or more keywords, a bid for one or more URLs or other outputs appearing in search results, or a combination of one or more keywords and one or more URLs or other outputs appearing in search results. Bids may be received from bidders for auction bundles, click-through rates for web page placements may be obtained for auction bundles, and the bidders with the highest prices for the auction bundles may be determined for a search query. A pricing engine for an auction bundle may be provided for determining a price of an auction bundle to maximize revenue in an online advertising auction. The advertisements of the bidders with the highest prices may be allocated to web page placements for display with query results. As used herein, a web page placement may mean a location on a web page designated for placing an advertisement for display.

As will be seen, the present invention may support many applications for offering an auction bundle in an online advertising auction. For example, online advertising applications may use the present invention for pricing auction bundles that may flexibly include auctioning advertisement placement for keywords of a search engines that may be displayed in a sponsored search area of a search results web page. Or online advertising applications may use the present invention for pricing auction bundles that may flexibly include auctioning advertisement placement for URLs output in the search results of search queries that may be displayed in a modified listing of search results. As will be understood, the various block diagrams, flow charts and scenarios described herein are only examples, and there are many other scenarios to which the present invention will apply.

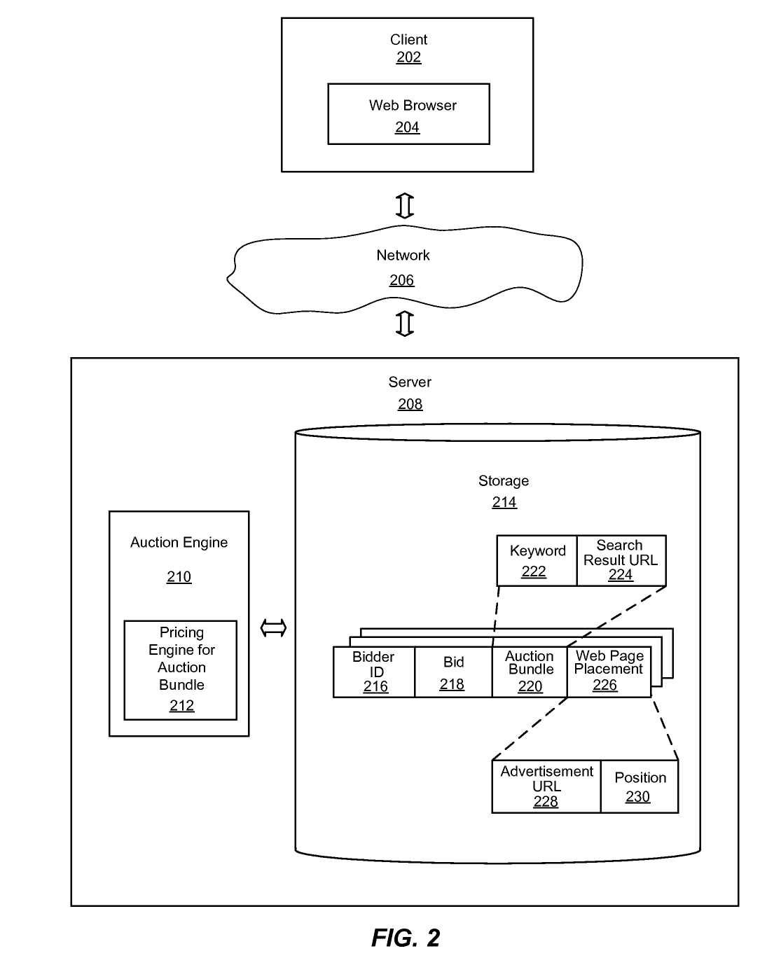

Turning to FIG. 2 of the drawings, there is shown a block diagram generally representing an exemplary architecture of system components for offering an auction bundle in an online advertising auction. Those skilled in the art will appreciate that the functionality implemented within the blocks illustrated in the diagram may be implemented as separate components or the functionality of several or all of the blocks may be implemented within a single component. For example, the functionality for the pricing engine for an auction bundle 212 may be implemented as a component within the auction engine 210. Or the functionality of the pricing engine for an auction bundle 212 may be implemented as a separate component from the auction engine 210. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query. The web browser 204 may include functionality for receiving a query entered by a user and for sending a query request to a server to obtain a list of search results. In general, the web browser 204 may be any type of interpreted or executable software code such as a kernel component, an application program, a script, a linked library, an object with methods, and so forth.

The server 208 may be any type of computer system or computing device such as computer system 100 of FIG. 1. In general, the server 208 may provide services for query processing and may include services for providing a list of auctioned advertisements to accompany the search results of query processing. In particular, the server 208 may include an online auction engine 210 for choosing advertisements for web page placements for an auction bundle 220 that may include a keyword 222, a URL 224 output as part of search results, or a combination of a keyword 222 and a URL 224 output as part of search results. The auction engine 210 may be operably coupled to a pricing engine for an auction bundle 212 for determining a price of an auction bundle 220. Each of these modules may also be any type of executable software code such as a kernel component, an application program, a linked library, an object with methods, or other type of executable software code.

The server 208 may be operably coupled to a database of information such as storage 214 that may include a bidder ID 216 that may be associated with a bid amount 218 for an auction bundle 220 to be displayed according to the web page placement 226. The auction bundle 220 may include a keyword 222 and/or a search result Uniform Resource Locator (URL) 224. The web page placement 226 may include an advertisement Uniform Resource Locator (URL) 228 for a web page and a position 230 for displaying an advertisement on the web page. Any type of advertisements may be associated with an advertisement URL 228. Bidders may have multiple auction bundles 220 representing several bid amounts for various web page placements and the payments for allocating web page placements for bids may be determined using auction bundle pricing to maximize the revenue of the auctioneer.

There may be many applications which may use the present invention for offering an auction bundle in an online advertising auction. For example, online advertising applications may use the present invention for pricing auction bundles that may flexibly include auctioning advertisement placement for keywords of search engines. Or online advertising applications may use the present invention for pricing auction bundles that may flexibly include auctioning advertisement placement for URLs output in the search results of search engines. For any of these applications, online advertisement auctions may flexibly offer auction bundles and price the auction bundles to maximize the revenue of the auctioneer.

In general, an auctioned bundle may include a keyword, a URL or other output appearing in search results, or a combination of a keyword and a URL or other output appearing in search results. Advertisers, for example, may bid on a keyword in a commonly used second price auction for web page placement of advertisements such as sponsored search links. Such advertisements may be displayed in a sponsored search area on a web page displaying the search results such as URLs to content requested by the search query. Each advertiser's per-click payment in a second price auction results from the bid of the advertisers immediately below: if all bidders have the same quality and other attributes, the n^{th} highest bidder pays the bid of n+1^{st} bidder. If bidders have different attributes, the bid can be adjusted based on quality, for example, advertisements may be ranked based on the product of bid and quality. See Edelman, B., and Ostrovsky, M., Strategic Bidder Behavior in Sponsored Search Auctions, Decision Support Systems Volume 43, Issue 1, pages 192-198, February 2007 for further details on a second price auction for keywords in a search engine. The product of a bid and quality is equal to one form of the gain to a web page placement.

Advertisers may also bid on a URL appearing in search results in an auction bundle. Instead of bidding on the input of a search engine like a keyword or phrase of a search query, advertisers may bid on an output of the search engine that is displayed in response to a search query. The output from the search engine may include a URL, filename, or other address to any content, text, media or information. Additionally, the output may include a title, domain, words, sponsored results, or other item output as part of search results. A winning bidder may pay a search engine operator to display an advertisement as part of the search results. A bidder may also bid to display an advertisement on multiple outputs of the search engine. In an implementation, a modified search result may include an advertisement in the modified search result. In another implementation, the advertisement may be displayed in the sponsored search area of the web page with search results. In various other implementations, an advertisement may be displayed conditionally based upon the ranking of the URL listed in the search results. In yet another implementation, an advertisement may replace a search result. Moreover, a bidder may bid to disallow an advertiser from bidding for an advertisement on an output of the search engine to modify any listing of the bidder appearing in the search results, including its URL or name. See co-pending U.S. patent application Ser. No. 11/739,242, entitled “SYSTEM FOR DISPLAYING ADVERTISEMENTS ASSOCIATED WITH SEARCH RESULTS,” assigned to the assignee of the present invention, for further details.

Advertisers may also bid on both an input to a search engine, like a keyword, and an output of a search engine, like a URL appearing in search results, in an auction bundle. An advertiser may bid for a keyword and an output of a search result together, and may want to display an advertisement when both occur. Or a bid for an advertisement on an output of the search engine may also be limited by a keyword input in the search query. Thus an advertiser may bid on an output of the search engine for certain search queries. Such a limitation by a keyword input in the search query may improve the relevancy of the advertisement based on both the input and the output of the search engine.

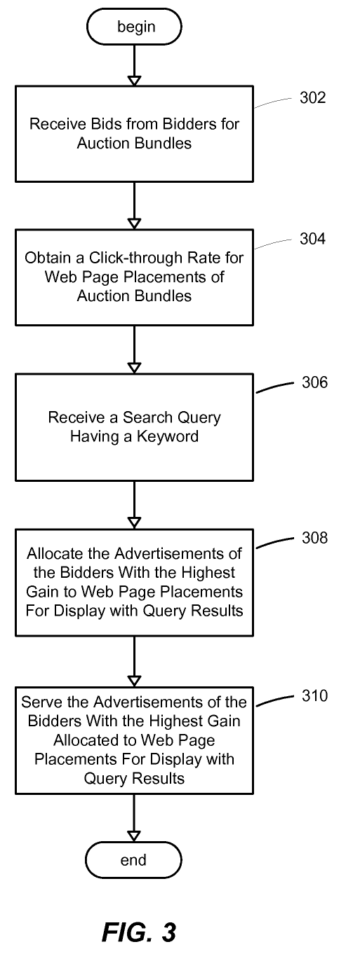

In order to conduct an online advertising auction of auction bundles, an auction mechanism may be implemented for offering an auction bundle and for pricing the auction bundles for a search query in an online advertising auction. FIG. 3 presents a flowchart generally representing the steps undertaken in one embodiment for offering an auction bundle in an online advertising auction. At step 302, bids may be received from bidders for auction bundles. In an embodiment, a bid may be received from a bidder for a keyword in a search query, or a bid for a URL in the search results, or a bid for the combination of a keyword in the search query and a URL in the search results.

In an implementation of an auction bundle with a bid for only one or more keywords, an advertiser i may bid for one of j web page placements of advertisements based on a keyword. Whenever that keyword appears in the search, j slots of advertisements appear in the results. In an embodiment, the web page placements of the j advertisements may appear in a sponsored search area of the search results page displayed. Each advertiser i may have a private value for each click through that is submitted as a bid for a keyword. This value may be independent of the position or location of the web page placement allocated to an advertisement.

In an implementation of an auction bundle with a bid for only one or more URLs in the search results, an advertiser i may bid to display an advertisement as part of the search results based on a URL in the output of the search results. In an embodiment, an advertisement may be displayed in one or more listing of the search results that may be modified to include the advertisement. Accordingly, the advertisements of winning bidders may appear in the algorithmic search results area of the search results page. Each advertiser i may have a private value for each click through that is submitted as a bid for a URL. This value may be independent of the position or location of the URL in the listing of search results.

In an implementation of an auction bundle with a bid for the combination of a keyword in the search query and a URL in the search results, an advertiser i may bid for one of j web page placements of advertisements based on a keyword and may simultaneously bid to display an advertisement as part of the search results based on a URL in the search results. In an embodiment, the advertisement of a winning bidder for a keyword may be allocated to one of the j web page placements in a sponsored search area of the search results page and the advertisement of the winning bidder for a URL in the search results may appear in the algorithmic search results area of the search results page. Each advertiser i may have a private value for each click that is submitted as a bid for the combination of the keyword in the search query and the URL in the search results.

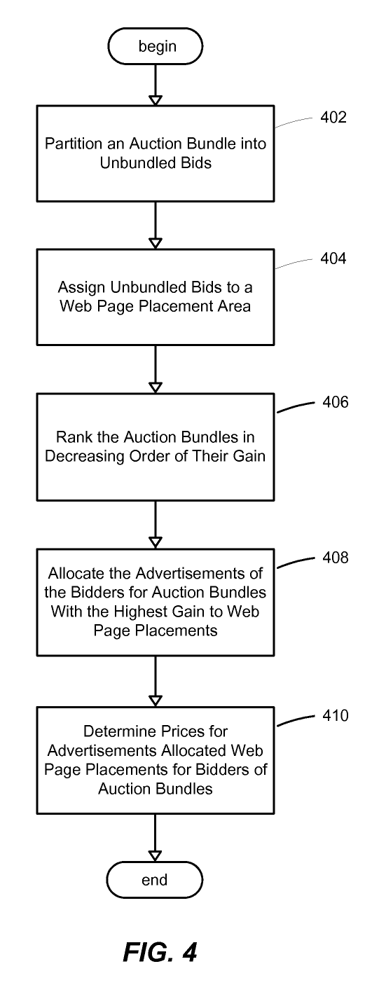

After bids may be received from bidders for auction bundles, click-through rates for web page placements may be obtained for auction bundles at step 304. At step 306, a search query having one or more keywords may be received, and the advertisements of the bidders with the highest gain may be allocated to web page placements for display with query results at step 308. FIG. 4 below describes in more detail the steps for allocating the advertisements of the bidders with the highest gain to web page placements for display with query results. The advertisements of winning bidders for a keyword in the search query may appear in the sponsored search results area of the search results page, and the advertisements of winning bidders for a URL in the search results may appear in the algorithmic search results area of the search results page. At step 310, the advertisements of the bidders with the highest gain allocated to web page placements may be served for display with query results.

FIG. 4 presents a flowchart generally representing the steps undertaken in one embodiment for allocating the advertisements of bidders to web page placements for display with query results for a search query in an online advertising auction. At step 402, an auction bundle may be partitioned into unbundled bids. For instance, an auction bundle that may include only multiple bids on the input of a search engine for sponsored search advertisements may be partitioned into individual bids on the input of the search engine. Similarly, an auction bundle that may include only multiple bids on the output of the search engine may be partitioned into individual bids on the output of the search engine for algorithmic search results displayed. In an embodiment, if the auction bundle includes one or more bids on the input of the search engine for a sponsored search advertisement and one or more bids on the output of the search engine for algorithmic search results displayed, then the auction bundle may be partitioned into pairs of bids that each includes a unique combination of one of the multiple bids on the input of the search engine for a sponsored search advertisement and one of the multiple bids on the output of the search engine for algorithmic search results displayed. Note that in the sequel and FIG. 4, the unbundled bids resulting from partitioning auction bundles are also referred to as auction bundles because they are still auction bundles but possibly smaller. At step 404, the unbundled bids may be assigned to a web page placement area. As used herein, a web page placement area means an area of a web page with one or more web page placement locations designated for placing an advertisement for display. For example, each bid that matches the output of the search engine for an algorithmic search result in an auction bundle may be assigned to a web page placement area for algorithmic search results. Similarly, each bid that matches the input of the search engine for sponsored search advertisements in an auction bundle may be assigned to a web page placement area for display of sponsored search advertisements. In an embodiment, the web page placement area for the output of the search engine for algorithmic search results may be represented by a matrix where each column, c, represents a search result and each row represents a web page placement, p, for allocating an advertisement for display with the search result. The web page placement area for display of sponsored search advertisements may be represented by the c+1^{st} column of this matrix, which will be referred to as column s, for allocating an advertisement for display on the search results web page.

At step 406, the auction bundles that include a bid which matches the input or the output may be ranked in decreasing order of their gain. In general, the gain may be computed as a function of many factors that may help rank bids. In one embodiment, the gain to a web page placement may be equal to the product of the bid and the CTR of the placement. In addition, in one embodiment, the gain may be computed in advance exhaustively over all possible web page placements, and in another embodiment, the gain may be computed incrementally after every web page placement. Since the number of web page placements is usually a small number, even the exhaustive computation is not expected to be expensive. Moreover, if multiple bundles from the same bidder are bids for the same the input or output, only the bid with the highest gain needs to be considered.

At step 408, the advertisements of bidders for auction bundles with the highest gain may be allocated to available web page placements. In general, the auction bundles may be allocated in decreasing order of their gain until the available web page placements are allocated; and, if a bidder has been already allocated a web page placement, then the auction bundle may not be processed and the next auction bundle in decreasing order may be processed. In processing each auction bundle, each bid that matches the input of the search engine for sponsored search advertisements in an auction bundle may be processed first, and then each bid in the auction bundle that matches the output of the search engine for an algorithmic search result may be processed following the order of the algorithmic search results. If an auction bundle includes a bid that matches the input of the search engine for sponsored search advertisements, then an advertisement of the bidder for that auction bundle may be allocated the next unassigned web page placement in the web page placement positions for sponsored search advertisements. If an auction bundle includes a bid that matches the output of the search engine for an algorithmic search result, then an advertisement of the bidder for that auction bundle may be allocated the next unassigned web page placement in the web page placement positions for that algorithmic search result.

And at step 410, prices may be determined for advertisements allocated to web page placements for winning bidders of auction bundles including both sponsored search advertisement for bidding on the input of the search engine and algorithmic search results for bidding on the output of the search engine. In an embodiment, a second price auction method may be used to compute the gain where advertiser i's per-click payment may be based upon the bid*CTR_{z,j+1} of advertiser z, the next highest bidder whose advertisement may be allocated a web page placement j+1 that is immediately below web page placement j of advertiser i's advertisement.

Consider p to be the position in the columns c of the matrix representing the web page placement area for the output of algorithmic search results and p′ to be the position in the column s that represents the web page placement area for sponsored search advertisements. If a winning auction bundle includes only a bid for a keyword in a search query with an advertisement allocated in the column s for a sponsored search, the price charged to an advertiser may be computed as (CTR(s,p′+1)*B(s,p′+1))/CTR(s,p′), where CTR(s,p′) is the CTR of the auction bundle allocated to the position p′ in the column s, and CTR(s,p′+1) and B(s,p′+1) are the CTR and the bid of the bidder at the next position p′+1 in the column s.

If a winning auction bundle includes only a bid on the output in the algorithmic search results with an advertisement allocated in the column c for a search result, the price charged to an advertiser may be computed as MAX(CTR(c,p+1)*B(c,p+1), CTR(s,last)*B(s,last))/CTR(c,p), where CTR(c,p) is the CTR of the auction bundle allocated the p-th web page placement in the column c, CTR(c,p+1) and B(c,p+1) are the CTR and the bid of the advertiser at the position p+1 in the column c, and CTR(s,last) and B(s,last) are the CTR and the bid of the advertiser at the last position in the column s. Note that a virtual competitor, such as the bidder of the last position for sponsored search bids, may be used to ensure competition for bidding. Those skilled in the art will appreciate that other implementations of a virtual competitor may be used.

If a winning auction bundle includes both a bid on the output in the algorithmic search results with an advertisement allocated in the column c for a search result and a bid for a keyword in a search query with an advertisement allocated in the column s for a sponsored search, the price charged an advertiser may be computed as (CTR(c,p+1)*B(c,p+1)+CTR(s,p′+1)*B(s,p′+1))/CTR(c,p,s,p′), where CTR(c,p,s,p′) is the CTR of the auction bundle allocated web page placements p and p′ in the columns c and s, respectively, and CTR(c,p+1) and B(c,p+1) are the CTR and the bid of the bidder at the next position p+1 in the column c, and CTR(s,p′+1) and B(s,p′+1) are the CTR and the bid of the bidder at the next position p′+1 in the column s.

Once prices may be determined for advertisements allocated to web page placements for winning bidders of auction bundles including both sponsored search advertisement for bidding on the input of the search engine and algorithmic search results for bidding on the output of the search engine, processing may be finished for allocating the advertisements of bidders to web page placements for display with query results for a search query in an online advertising auction.

Thus the present invention may flexibly price auction bundles in an online advertising auction to maximize revenue for the auctioneer. Advertisers may simultaneously or separately bid for sponsored search advertisements and for advertisements based upon the output in the search results. The system and method of the present invention supports offering an auction bundle to transparently conduct an online advertising auction for both bidding for an input of a search engine and bidding for an output of search engine. Moreover, the present invention may seamlessly support simultaneous display of advertisements for sponsored search and for search query results.

As can be seen from the foregoing detailed description, the present invention provides an improved system and method for offering an auction bundle in an online advertising auction. A pricing engine for an auction bundle may determine a price of an auction bundle that may include a bid for an input of a search engine such as a keyword, an output of search engine such as a URL appearing in search results, or a combination of an input and an output of a search engine. Web page placements may be allocated for advertisements of auction bundles with the highest gain and payment for each of the advertisements allocated to web page placements may be calculated using second price auction techniques applied to auction bundles. In another embodiment, a different auction technique may be used. Many applications may use the present invention for offering an auction bundle in an online advertising auction. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for an online advertising auction, comprising:
an auction engine for allocating a plurality of advertisements to a plurality of web page placements in an online advertising auction of auction bundles that each may include a bid on an input of a search engine and another bid on an output of the search engine; and
a storage operably coupled to the auction engine for storing a plurality of bids each associated with an auction bundle that may be allocated to the plurality of web page placements in the online advertising auction of auction bundles.

2. The system of claim 1 further comprising a pricing engine for an auction bundle operably coupled to the auction engine for determining pricing of the auction bundles that each may include the bid on the input of the search engine and the another bid on the output of the search engine.

3. A computer-readable medium having computer-executable components comprising the system of claim 1.

4. A computer-implemented method for an online advertising auction, comprising:
receiving a query having one or more keywords;
determining a plurality of bidders in order by highest gain for a plurality of auction bundles for the query;
allocating a plurality of advertisements of the plurality of bidders in order by highest gain for the plurality of auction bundles to a plurality of web page placements for display with query results; and
outputting the plurality of advertisements allocated to the plurality of web page placements for display with query results.

5. The method of claim 4 further comprising receiving a plurality of bids from the plurality of bidders for the plurality of auction bundles.

6. The method of claim 5 wherein receiving the plurality of bids from the plurality of bidders for the plurality of auction bundles comprises receiving a value per click from a bidder of the plurality of bidders for the one or more keywords.

7. The method of claim 5 wherein receiving the plurality of bids from the plurality of bidders for the plurality of auction bundles comprises receiving a value per click from a bidder of the plurality of bidders for an output of the query results.

8. The method of claim 4 further comprising obtaining a click-through rate for each of the plurality of auction bundles.

9. The method of claim 4 wherein determining the plurality of bidders in order by highest gain for the plurality of auction bundles for the query comprises determining a price for at least one of the plurality of auction bundles that include a bid only for the one or more keywords.

10. The method of claim 4 wherein determining the plurality of bidders in order by highest gain for the plurality of auction bundles for the query comprises determining a price for at least one of the plurality of auction bundles that include a bid only for a URL in the query results.

11. The method of claim 4 wherein determining the plurality of bidders in order by highest gain for the plurality of auction bundles for the query comprises determining a price for at least one of the plurality of auction bundles that include a bid for the one or more keywords and another bid for a URL in the query results.

12. The method of claim 9 wherein determining a price for at least one of the plurality of auction bundles that include a bid only for the one or more keywords comprises using a payment calculation for a second price keyword auction.

13. The method of claim 10 wherein determining a price for at least one of the plurality of auction bundles that include a bid only for a URL in the query results comprises using a payment calculation that includes a bid of the next highest bidder for the URL.

14. The method of claim 11 wherein determining a price for at least one of the plurality of auction bundles that include a bid for the one or more keywords and another bid for a URL in the query results comprises computing a sum of a payment calculation for a second price keyword auction and a payment calculation that includes a bid of the next highest bidder for the URL.

15. The method of claim 4 wherein allocating the plurality of advertisements of the plurality of bidders in order by highest gain for the plurality of auction bundles to a plurality of web page placements for display with query results comprises modifying a listing of query results.

16. The method of claim 4 wherein allocating the plurality of advertisements of the plurality of bidders in order by highest gain for the plurality of auction bundles to a plurality of web page placements for display with query results comprises allocating at least one of the plurality of advertisements to at least one of the plurality of web page placements in a sponsored search area of a web page displaying the query results.

17. A computer-readable medium having computer-executable instructions for performing the method of claim 4.

18. A computer system for an online advertising auction, comprising:
means for determining a plurality of bidders in order by highest gain for a plurality of auction bundles for a search query;
means for allocating a plurality of advertisements of the plurality of bidders in order by highest gain for the plurality of auction bundles to a plurality of web page placements for display with search query results; and
means for outputting the plurality of advertisements allocated to the plurality of web page placements for display with query results.

19. The computer system of claim 18 wherein means for determining the plurality of bidders in order by highest gain for the plurality of auction bundles for the search query comprises means for calculating a price of at least one of the plurality of auction bundles that includes a bid only for a keyword of the search query.

20. The computer system of claim 18 wherein means for determining the plurality of bidders in order by highest gain for the plurality of auction bundles for the search query comprises means for calculating a price of at least one of the plurality of auction bundles that includes a bid only for a URL in the search query results.
